(19) United States
(12) Patent Application Publication
(10) Pub. No.: US 2007/0274332 A1
(43) Pub. Date: Nov. 29, 2007

(54) Method of Minimising Dead Time of a Path Set-Up and Tear-Down Process in a Centrally Controlled Network

(76) Inventors: Miguel De Vega Rodrigo, Lambert Brussels (BE); Robert Pleich, Munchen (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/547,219

(22) PCT Filed: Feb. 2, 2005
(86) PCT No.: PCT/EP05/01403

§ 371 Date: Sep. 29, 2006

(30) Foreign Application Priority Data
Mar. 31, 2004 (GB) 0407155.1

(51) Int. Cl. H04L 12/00

(52) U.S. Cl. 370/412; 398/53

(57) ABSTRACT

In one aspect, a method of minimising dead time of a path set-up and tear-down process in a centrally controlled network comprises receiving at a central controller a path setup message from a node is provided. The controller sends a tear-down signal to a node which is sending information on an existing path and sends a set-up signal to each node in a new path. The transmission time for each set-up and tear-down signal is determined, an order of sending derived and each signal is sent in order, such that each signal arrives at its destination at an optimal time with respect to each other signal, thereby minimising dead time.

This invention relates to a method of minimising dead time of a path set-up and tear-down process in a centrally controlled network, in particular for optical networks.

Conventionally path set-up and tear-down in centralised networks has been carried out in relatively low capacity networks, so dead time has not been a major concern. However, with the increasing use of high capacity optical networks, dead time is becoming more significant. When an old path is torn down to allow a new one to be made, there is a dead time when no data can be sent which is related to the switching time of the slowest switch in the two paths. It is desirable that this should be minimised.

In accordance with the present invention, a method of minimising dead time of a path set-up and tear-down process in a centrally controlled network comprises receiving at a central controller a path setup message from a node; sending a tear-down signal to a node which is sending information on an existing path; and sending a set-up signal to each node in a new path; wherein the transmission time for each set-up and tear-down signal is determined and an order of sending derived; and wherein each signal is sent in order, such that each signal arrives at its destination at an optimal time with respect to each other signal, thereby minimising dead time.

The present invention allows optimisation of path setup and teardown in centralized optical networks enabling the dead time to be reduced as much as possible.

Preferably, the controller sends a test signal to each node to determine the propagation delay of each link before deriving the signal sending order.

The controller may have to queue signals, if it can only process and send one at a time, but preferably, the central controller operates in parallel, such that each signal can be sent at a time resulting in the signal arrive at its destination substantially simultaneously with the other signals.

Although the method can be applied to many types of network, preferably, the network is an optical network.

An example of a method of minimising dead time of a path set-up and tear-down process in a centrally controlled network according to the present invention will now be described with reference to the accompanying drawings in which:

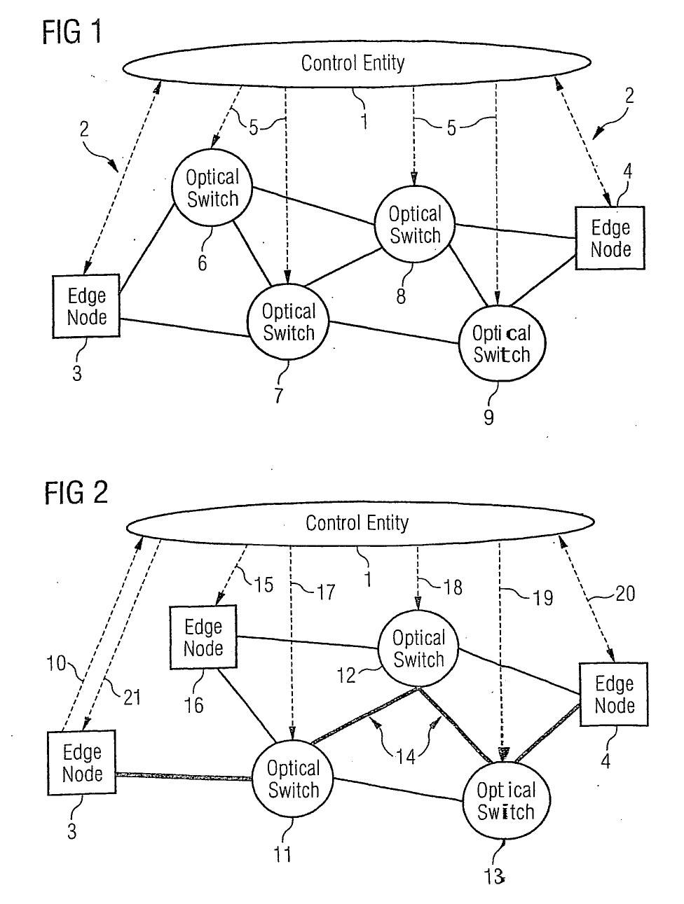

FIG. 1 illustrates a typical centralised architecture for which the method of the present invention is applicable; and,

FIG. 2 illustrates setting tip an optical path in the architecture of FIG. 1.

A typical centrally controlled optical network is illustrated in FIG. 1. Signalling in centralized networks is done via one or several control entities which are in charge of coordinating the rest of the network elements. A control entity 1 communicates 2 with edge nodes 3, 4. In order to set up a particular path through the network, path setup or tear down messages 5 must be sent to the relevant optical switch 6, 7, 8, 9, so that a connection between the edge nodes via the chosen optical switches is made or destroyed accordingly.

Consider the case where an old path is destroyed in order to create a new path. Between the destruction of the old path and the creation of the new one, there is a time interval in which no information can be sent due to the path setup and teardown signalling. This time interval is called the dead time which is equal to t2−t1−tswitch, where t1 is the time when the last bit of information for the old connection was sent, t2 is the time when the first bit of information for the new connection is sent, and tswitch is the switching time of the slowest switch belonging to either the old path or the new path. That is, the dead time is the time between sending the last bit of the old connection and the first bit of the new connection, but without taking into account the slowest switching time in any of the connections.

A particular type of optical network for which the invention is applicable is a network with a two way reservation scheme. In such schemes two types of signalling messages are necessary in order to make a connection between two edge nodes, a path setup message to initiate the connection and an acknowledge (ACK) message to confirm or deny the availability of resources for the connection. Generally, the centralized path setup and teardown procedure has been implemented in lower capacity networks, where the dead time is not considered to be particularly important, so no particular attention was paid to the exact synchronization of the signals. However, in optical networks with link speeds in the order of Gbps, a dead time in the order of milliseconds can mean that Mbits of bandwidth are wasted.

In FIG. 2, a specific example of setting up a path between the edge nodes 3, 4 is shown. A path setup message 10 is sent from the edge node 3 to the control entity 1, which then generates and sends a setup signal to each one of a plurality of nodes belonging to a new path 14—in this case optical switches 11, 12, 13 and edge node 4. In addition, the control entity 1 sends a teardown signal 15 to a source edge node 16 that was sending information through an old path. The teardown signal 15 is sent first, so that no information gets lost, but individual setup signals 17, 18, 19, 20 to the switches and nodes 11, 12, 13, 4 in the new path 14 were conventionally sent in no particular order. Finally, when the new path is set up, an ACK message 21 is sent.

The lengths of the links of the signalling network vary, so that the transmission time of each signalling message 15, 17, 18, 19, 20 differs from the others. This difference might be non-negligible in Metro networks and considerable in Core networks, where the distance from the control entity to the nodes can be of the order of hundreds of kilometres. Therefore the time elapsed between the arrival of the teardown signal 15 at the source edge node 16 of the old path and the arrival of the ACK signal 21 at the edge node 3 which is the source edge node of the new path, the dead time, can be considerable. Thus, conventional signalling methods lead to large and unpredictable dead times.

The present invention addresses this problem by sending the teardown 15, path setup 17, 18, 19, 20 and ACK 21 signals, such that they all arrive at their respective destinations at approximately the same time. This means that it is possible to reduce the dead time to zero in the case were sufficiently good synchronization of the signals is provided, and at the very least, the dead time is significantly reduced. The invention takes advantage of the behavioural predictability of centralized optical networks in order to create a path setup and teardown method that manages the bandwidth in a highly efficient way.

Again, the example of FIG. 2 can be used to explain the present invention. When the edge node 3 sends its path setup message 10 to the control entity 1, the control entity must then work out the order in which to send the signals 15, 17, 18, 19, 20, 21, so that they all arrive at the same time. To do this, the propagation delay of each signalling link has to be taken into account. Generally, the propagation delay, equal to signal propagation speed divided by length of the line, is a well known parameter which can be provided to the control entity by various means. However, there will be some circumstances where this parameter is not known, in which case the control entity has to calculate the propagation delay by sending a test signal to each element in the network and measuring the time until a response arrives.

Having obtained the propagation delays, then it is necessary to derive a time at which each signal has to be sent. If the control entity is capable of working in parallel and able to send many signals at a time, then it simply needs a timer in order to send each signal at its proper time, so that they all arrive at their destinations at the same time. However, there may be situations where the control entity can only send one signal at a time. This means that there is only one waiting queue and one processor to analyze and send the signals, so it is necessary to manage the priorities in the queue correctly. Each signal is given a priority in the queue according to its propagation time, so that signals with a bigger propagation time are given a higher priority in order to be sent first. The queuing discipline is not a normal one in which a signal enters the processor as soon as it is free. The processor knows at which time each signal has to be sent, so it begins processing the next signal only when it is time to send it, and not before. If a signal is sent before or after its calculated time, the dead time is increased. Therefore the queuing discipline will try to serve and to send each signal at its proper time.

The mechanism is especially important for highly loaded adaptive path optical networks (APON). When APON networks are highly loaded their lambda switching regime is reduced to virtually zero, so that one burst is sent right after another, in the same way as in optical burst switching (OBS) networks. This situation is highly demanding since it reduces the life of a path to a burst transmission time. It therefore requires optical paths to be dynamically created and destroyed burst after burst. Without an efficient path setup and teardown mechanism that reduces the dead time as much as possible, high loaded APON networks may lead to a poor bandwidth usage.

The present invention allows the dead time between teardown and setup to be reduced to zero, leading to better bandwidth usage and the possibility of transferring more information through the same network. Furthermore, it optimises the operation of highly loaded APON networks whilst still complying with the philosophy of centralised networks that complexity should be kept out of the edge nodes and optical switches. No hardware modification is required, so the method can be applied to existing systems without significant cost.

1.-4. (canceled)

5. A method of minimising dead time of a path set-up and tear-down process in a centrally controlled network, comprising:
receiving at a central controller a path setup message from a node;
sending a tear-down signal to a node which is sending information on an existing path; and
sending a set-up signal to each node in a new path,
wherein the propagation delay time for each set-up and tear-down signal is determined and an order of sending derived, and
wherein each signal is sent in an order such that each signal arrives at its destination at an optimal time with respect to each other signal, thereby minimising dead time.

6. The method according to claim 5, wherein the central controller operates in parallel such that each signal can be sent at a time resulting in the signal arriving at its destination substantially simultaneously with the other signals.

7. The method according to claim 5, wherein the controller sends a test signal to each node to determine the propagation delay time of each link before deriving the signal sending order.

8. The method according to claim 8, wherein the central controller operates in parallel such that each signal can be sent at a time resulting in the signal arriving at its destination substantially simultaneously with the other signals.

9. The method according to claim 5, wherein the network is an optical network.
